(19) United States
(12) Patent Application Publication
(10) Pub. No.: US 2007/0041300 A1
(43) Pub. Date: Feb. 22, 2007

(54) Optical disk apparatus and reproduction signal processing circuit

(76) Inventor: Hiroyuki Minemura, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/342,691

(22) Filed: Jan. 31, 2006

(30) Foreign Application Priority Data
Aug. 22, 2005 (JP) 2005-239272

(51) Int. Cl. G11B 20/10

(52) U.S. Cl. 369/59.22

(57) ABSTRACT

In an optical disk apparatus that uses reproduced signals from a plurality of beam spots to reduce the influence of crosstalk, stable clock generation is implemented. The optical disk apparatus includes a delay adjusting circuit for the reproduced signals from the respective spots outside a PLL loop. With the delay adjusting arrangement, a PLL loop delay is reduced. A clock generating circuit that implements a stable feedback control operation is thus provided. Stable generation of a clock thereby becomes possible, so that a reproducing operation from a high-capacity optical disk is stabilized.

### INCORPORATION BY REFERENCE

The present application claims priority from Japanese application JP 2005-239272 filed on Aug. 22, 2005, the content of which is hereby incorporated by reference into this application.

### BACKGROUND OF THE INVENTION

The present invention relates to an optical disk apparatus and a reproduced signal processing circuit that enables reproduction of information recoded at high track density, using a plurality of beam spots.

As a technology for achieving higher density of optical disks, there is proposed a crosstalk canceling technology for reducing the influence of crosstalk from an adjacent track using a plurality of beam spots. As the crosstalk canceling technology, JP-A-9-320200, which corresponds to U.S. Pat. No. 5,835,467, JP-A-2001-266382, and JP-A-7-176052 describes the technology of a type in which a main beam spot is arranged on a track targeted for reproduction and sub beam spots are arranged on two tracks adjacent to the track targeted for reproduction. Further, there has been proposed a method in which a region for crosstalk detection (learning) is provided on the optical disk and by tracing the region by three beams, a desired crosstalk cancellation condition is obtained. The method is disclosed in JP-A-2003-196840, which corresponds to U.S. 2003/0117914 A1. There has also been devised a method in which using a correlation between a main track and tracks adjacent to the main track, an algorithm is constituted, and by using the algorithm, desired information is obtained. This method is disclosed in JP-A-2000-113595. There has also been proposed a method of removing a leakage signal using various algorithms for a signal processing system. This method is disclosed in JP-A-5-325196.

In these technologies, in order to adjust the gain and the frequency characteristic of a reproduced signal from the sub beam spots, equalization processing is performed, based on a reproduced signal from the main beam spot. Then, subtraction processing is performed, thereby reducing the influence of the crosstalk.

Further, “Jpn. J. Appl. Phys. Vol. 44, No. 5B, pp. 3467-3470 (2005)” (hereinafter referred to as Nonpatent Document 1) and “Jpn. J. Appl. Phys. Vol. 44, No. 5B, pp. 3445-3448 (2005)” (hereinafter referred to as Nonpatent Document 2) disclose a method of automatically defining an equalization condition for reproduced signals from the main and sub beam spots, using an automatic equalization algorithm based on partial response maximum likelihood (PRML) reproduction technology.

FIG. 2 shows a block diagram explaining a crosstalk canceling method described in Nonpatent Document 1. FIG. 3 shows a block diagram explaining a crosstalk canceling method described in Nonpatent Document 2. The method has the same configuration as that in FIG. 2. According to the technologies disclosed in these Nonpatent Documents, an influence caused due to tilting or a track offset of an optical disk medium or the like can be automatically canceled. Further, by using an adaptive PRML method together with this technology, linear recording density is also enhanced. These Nonpatent Documents show that, by using such technologies and using a laser light source with a wavelength of 405 nm and an objective lens with a numerical aperture of 0.85, a storage capacity of 50 GB of a 120-mm-diameter optical disk can be implemented.

Needless to say, in order to reproduce information from an optical disk apparatus, it is important to reduce the influence of the crosstalk, improve signal quality, and binarize the information using a PRML method or the like. In order for a crosstalk canceling system and a binarization system to function properly, a clock generation scheme for stably generating operation clocks for implementation of these methods is essential. Nonpatent Documents 1 and 2 have not given any specific description about the clock generation scheme. Other conventional art has not disclosed a technology relating to the clock generation scheme for stably generating the clocks under such a high density condition.

### SUMMARY OF THE INVENTION

In order to clarify a problem to be solved by the present invention, a reproducing circuit-for an optical disk apparatus comprised of the crosstalk canceling system and the clock generation system, which combines conventional technologies, will be considered. The followings were first studied by the inventor of the present application. FIG. 5 is a block diagram of a reproducing circuit in which a clock generation scheme using a conventional common phase locked loop (PLL) circuit is added to the crosstalk canceling method described in Nonpatent Document 1. The common digital PLL circuit includes a phase detector, a low pass filter, and a voltage controlled oscillator (VCO). In this circuit, sample timings of A/D converters are controlled by a generated clock signal. Since the principle of operation of the PLL circuit is known, its description will be omitted. Such a PLL circuit constitutes a second-order feedback control loop. In FIG. 5, delay units for reproduced signals from three beam spots, which are simplified in FIGS. 2 and 3, are also illustrated in a specific manner. In this circuit, the amount of delay corresponds to an interval between the three beam spots. It is a common practice to set the interval between the main beam spot and the sub beam spot to approximately several micrometers so as to prevent beam separation on a photodetector and thermal energy interference between the three beam spots. Accordingly, the amount of adjustment to the delay between the main beam spot and the sub beam spot is equal to approximately 50-150 clocks, as shown in FIG. 5.

A problem in the configuration of the circuit in FIG. 5 is that as an input signal to the PLL circuit or a reference signal for clock control, a signal reproduced by a main beam before crosstalk cancellation must be used. FIG. 4 shows reproduced signals reproduced from the optical disk with the storage capacity of 50 GB described in Nonpatent Document 2 and shows a difference between the signal quality before and after the crosstalk cancellation. The signal quality before the crosstalk cancellation was very bad due to the influence of signals from tracks adjacent to a track targeted for reproduction. Further, the amplitude of a reproduced 2 Tw signal, which is the minimum-length signal, is closer and closer to zero. Thus, in the PLL circuit that causes the clock to track the edge of the reproduced signal, a stable operation was difficult. On the other hand, when the signal after the crosstalk cancellation that passes through a signal path indicated by a dotted line in FIG. 5 is used as the reference signal for a clock generator in the PLL circuit or the like, the signal quality is satisfactory. However, a delay corresponding to a time required for processing by the delay units and equalizers will occur in the feedback control loop. When the number of taps of each equalizer is approximately 10 taps, the amount of a delay caused by the equalizer becomes approximately 5 clocks. Accordingly, a delay caused by two delay units of 100 to 300 Tw, in which Tw indicates a clock interval, is dominant. In order to ensure the stable operation of the PLL circuit, the amount of the delay caused due to the delay units and the equalizers must be at most 50 clocks. Otherwise, the pull-in time of the PLL circuit will increase, so that performance of reading caused due to a random access or the like will be remarkably reduced.

FIGS. 6 to 8 show simulation results of a pull-in operation of a standard digital PLL circuit. Herein, calculations were performed on the feedback control loop in the PLL circuit indicated by a solid line in FIG. 5 in a recording condition with the recording density equivalent to 50 GB/side, in which a window width was set to 57 nm, a track pitch was set to 240 nm, and a 1-7 code was used. Then, an initial frequency deviation was set to 1%, and a loop delay was set to 10 Tw. FIG. 6 indicates the result of calculation of the oscillating frequency error of the VCO during the process of the pull-in operation for an isolated track free from the crosstalk. As shown in FIG. 6, after 500 Tw from the start of the pull-in operation, the frequency deviation of the clock becomes substantially zero, and the PLL circuit is settled. It can be therefore seen that the PLL circuit normally follows a reflected signal.

FIG. 7 shows the result of calculation when recording has been performed on a track adjacent to a track targeted for recording, and then crosstalk has been generated. It can been seen that due to the influence of a reduction in the signal quality caused due to the crosstalk as described above, the frequency deviation of the clock does not get close to zero.

FIG. 8 shows the result of calculation when the loop delay has been increased to 100 Tw under the recording condition in FIG. 6. It can be seen from FIG. 8 that, even if no crosstalk is generated, for example, the frequency of the clock is not stabilized when the loop delay is large, so that the PLL circuit performs an unstable operation.

FIG. 9 shows a model of a digital PLL circuit 70A used in the simulations. Referring to FIG. 9, a path that passes through a low pass filter 1 (LPF-1) 74 indicates a phase control path, while an integrating path comprised of a low pass filter 2 (LPF-2) 76, an adder 77, and a buffer 78 indicates a frequency control path.

An object of the present invention is to solve the problems described above, to provide a clock generation method suitable for being used together with a crosstalk canceling technology, and an optical disk apparatus that has a large capacity and stable reproduction performance.

In order to cause a signal that has subject to crosstalk cancellation processing to operate as a reference signal for a PLL circuit, the present invention provides a delay adjusting mechanism before A/D converters, thereby reducing the loop delay of the PLL circuit. Operation and advantages of a readout (reproduced) signal processing circuit with a delay adjusting mechanism and the optical disk apparatus according to the present invention will be described below.

FIG. 10 shows a block diagram of the readout signal processing circuit according to the present invention. An optical head not shown focuses beam spots on three adjacent information tracks on an optical disk. Reflected lights from the information tracks are received by three photodetectors and converted to electrical signals. The gain or/and the frequency characteristic of a signal 90 reproduced from a main beam spot is adjusted and equalization processing on the signal 90 is performed by an analog preequalizer 10. Likewise, the gains and/or the frequency characteristics of signals 91 and 92 reproduced from sub beam spots are adjusted and equalization processing is performed on the signals 91 and 92 by analog prequalizers 11 and 12, respectively. A delay adjust unit 20 adjusts a difference among irradiating positions of three spots in a track direction, as described above. The signals that have been supplied to the delay adjust unit 20 are converted to digital signals by A/D converters 30, 31, and 32. Then, the gain and the frequency characteristic of the reproduced signal from the main beam spot is adjusted by an equalizer 40 so that the adjusted signal becomes close to a partial response maximum likelihood (PRML) target signal. The gains and the frequency characteristics of the reproduced signals from the sub beam spots are adjusted by equalizers 41 and 42. Further, residual error correction after delay adjustment by the delay adjust unit 20 is performed on the reproduced signals from the sub beam spots by the equalizers 41 and 42. By subtracting these signals from the reproduced signal from the main beam spot by a subtracter 50, a crosstalk canceled signal 95 with the influence of crosstalk reduced therefrom is obtained. The crosstalk canceled signal is converted to a binary data sequence 93 by a PRML decoder 60. Then, recorded information is reproduced from the binary data sequence 93 by a format decoder not shown. A digital PLL circuit 70 is comprised of a phase detector 71, a low pass filter 72, and a VCO 73, and constitutes a control loop so that a clock 93 follows the reproduced signal with the influence of the crosstalk reduced therefrom. The equalizers 40, 41, and 42 are digital finite impulse response (FIR) filters. Each tap coefficient is synthesized using the target signal level of the PRML decoder and the binary data sequence 93, and is determined using a least mean square (LMS) method by a tap coefficient learning unit not shown. Such an automatic equalization algorithm is a known technology, and a specific method of the automatic equalization algorithm is described in Nonpatent Document 2 as well. Thus, a description about the specific method will be omitted herein. With the arrangement described above, the amount of the delay of the control loop of the PLL circuit can be drastically reduced than a configuration shown in FIG. 5. Further, the signal of good signal quality after crosstalk cancellation can be used as the reference signal. A stable operation of the PLL circuit thereby becomes possible.

Further, by using an optical disk apparatus according to the present invention, stable generation of a clock in the circuit of a crosstalk cancelling system becomes possible, so that a highly reliable optical memory with a large capacity can be implemented.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a reproducing circuit in an optical disk apparatus according to the present invention;

FIG. 2 is a block diagram explaining a conventional crosstalk canceling method;

FIG. 3 is a block diagram explaining a conventional crosstalk canceling method;

FIG. 4 is a diagram showing improvement in signal quality due to crosstalk cancellation;

FIG. 5 is a block diagram showing a reproducing circuit in which a combination of prior arts is used;

FIG. 6 shows a result of simulation of a pull-in operation of a standard digital PLL circuit;

FIG. 7 shows a result of simulation of a pull-in operation of the standard digital PLL circuit;

FIG. 8 shows a result of simulation of a pull-in operation of the standard digital PLL circuit;

FIG. 9 shows a model of the digital PLL circuit used in the simulations;

FIG. 10 is a block diagram of a readout signal processing unit according to the present invention;

FIG. 11 is a block diagram of a readout signal processing unit according to the present invention;

FIG. 12 shows a configuration of a binarization circuit in accordance with a PRML method of a compensation type;

FIG. 13 is a diagram showing a detailed configuration of a delay adjust unit;

FIG. 14 is a diagram showing a detailed configuration of a delay adjust unit;

FIG. 15 is a diagram showing a configuration of an optical disk apparatus according to the present invention; and

FIG. 16 shows experimental results according to the present invention.

### DETAILED DESCRIPTION OF THE EMBODIMENTS

Embodiments of the present invention will be described with reference to the drawings.

### First Embodiment

Reproducing Circuit

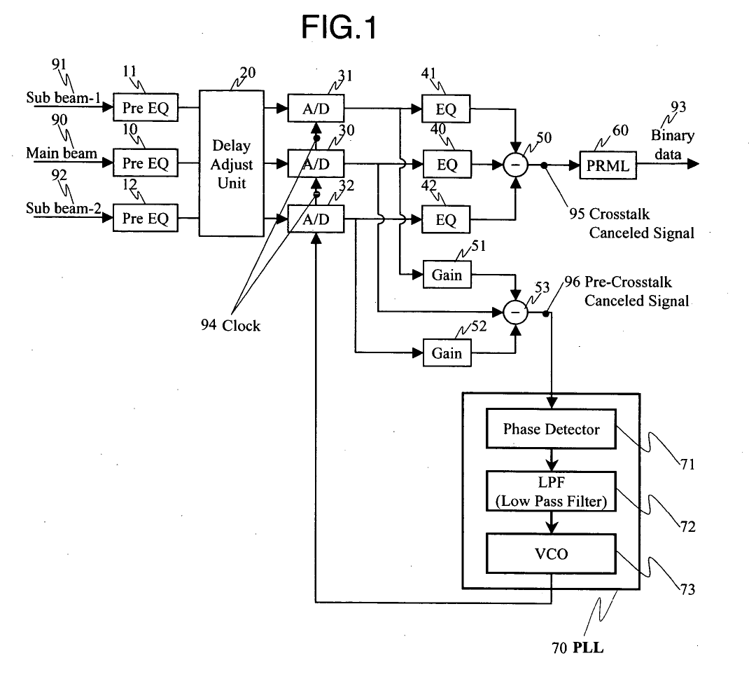

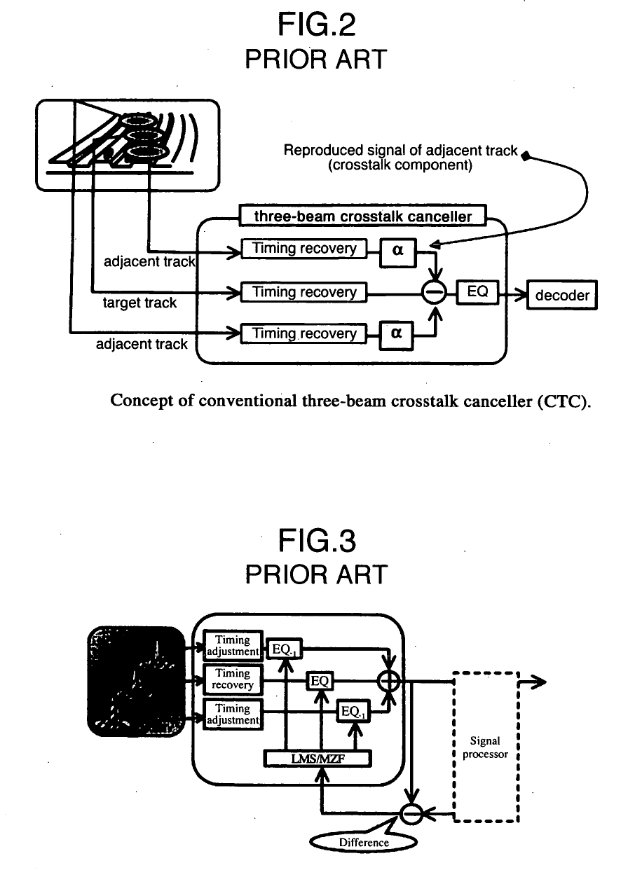

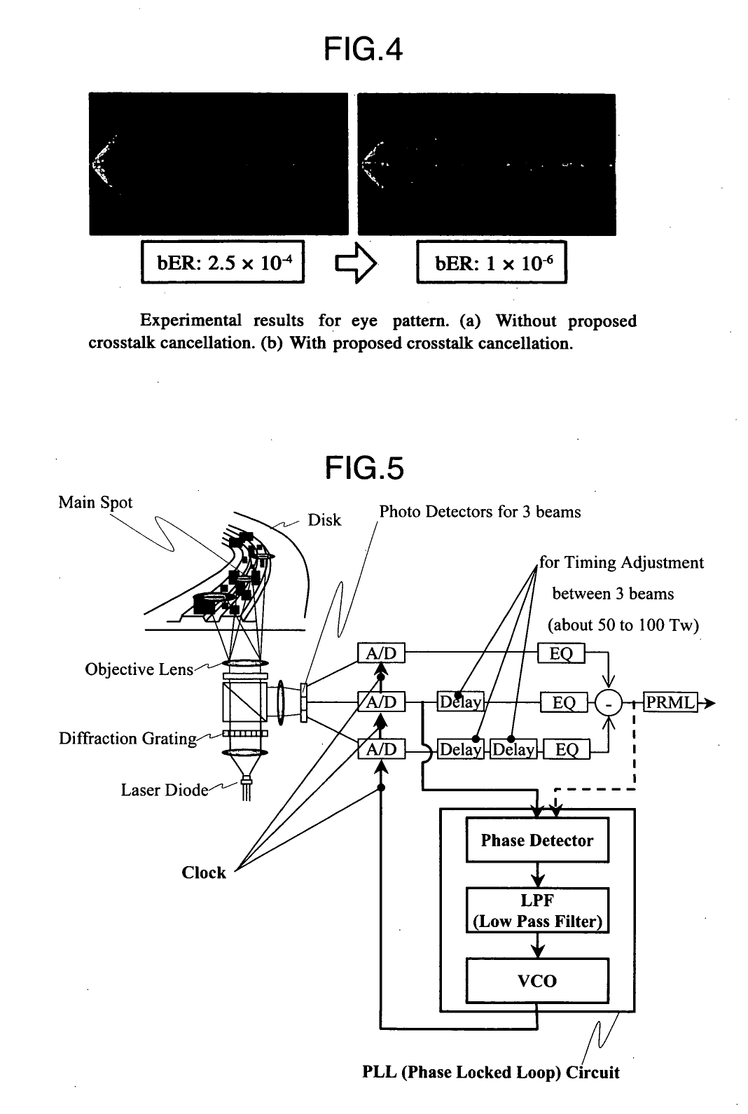

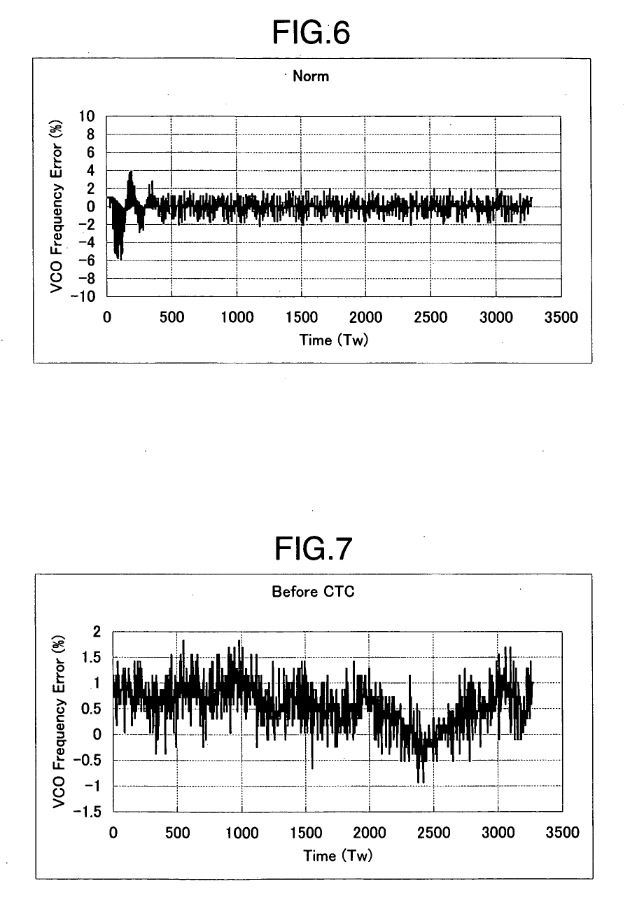

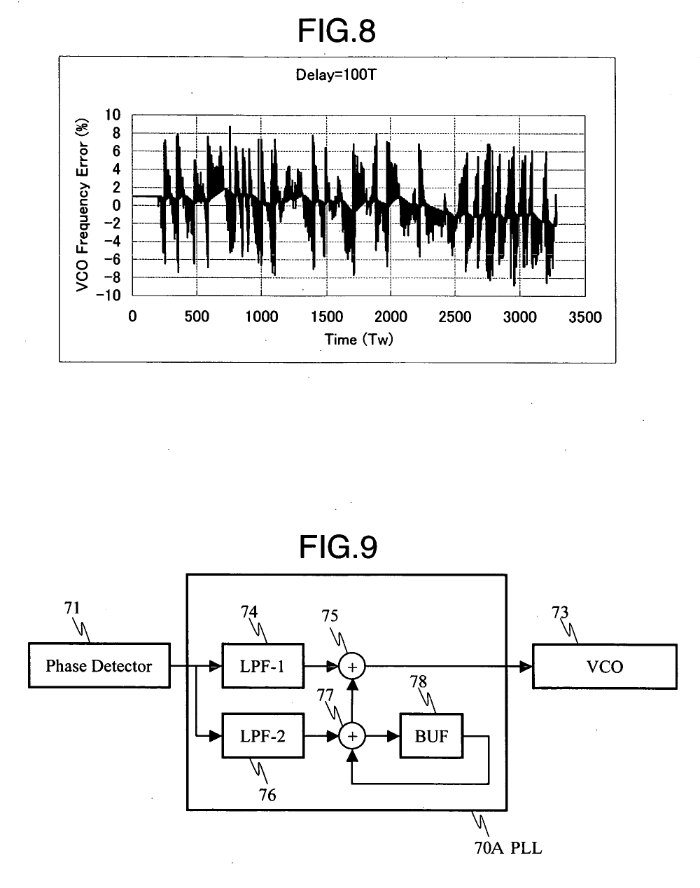

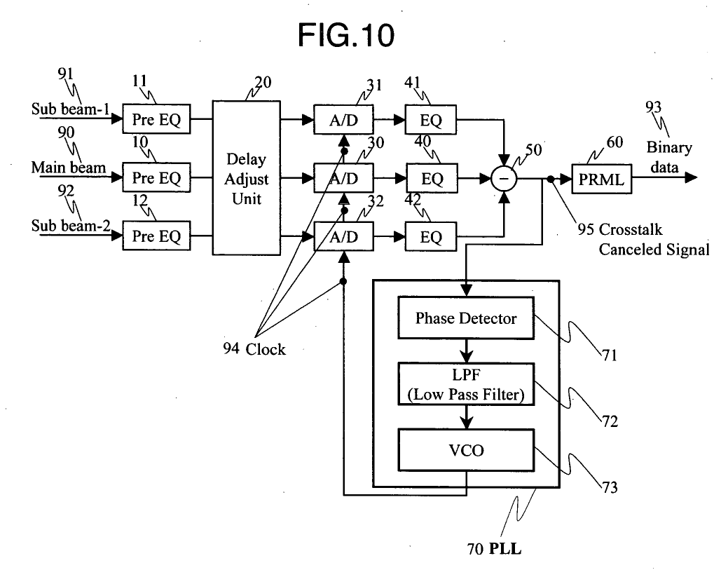

FIG. 1 shows a first embodiment of a reproducing circuit in an optical disk apparatus of the present invention. A basic operation is the same as that of the circuit in FIG. 10 described above. The circuit in this embodiment is so specifically configured that a pre-crosstalk canceled signal is used for reference in a PLL circuit 70 so as to improve tracking performance and stability at the time of the pull-in of the PLL circuit 70. A pre-crosstalk canceled signal 96 is generated by using digital signals obtained by the A/D converters 30, 31, and 32 and by using gain integrators 51 and 52 and a subtracter 53 in place of the equalizers 40, 41, and 42. With such an arrangement, the influence of a loop delay by the equalizers is avoided, and a signal on which only gain correction has been performed to reduce crosstalk can be input to the PLL circuit 70. The value of gain integrator 51 should be adaptively changed using a total sum of tap coefficients of the equalizer 41. The value of gain integrator 52 should be adaptively changed using a total sum of tap coefficients of the equalizer 42. These values indicate a DC value of the amount of crosstalk influence.

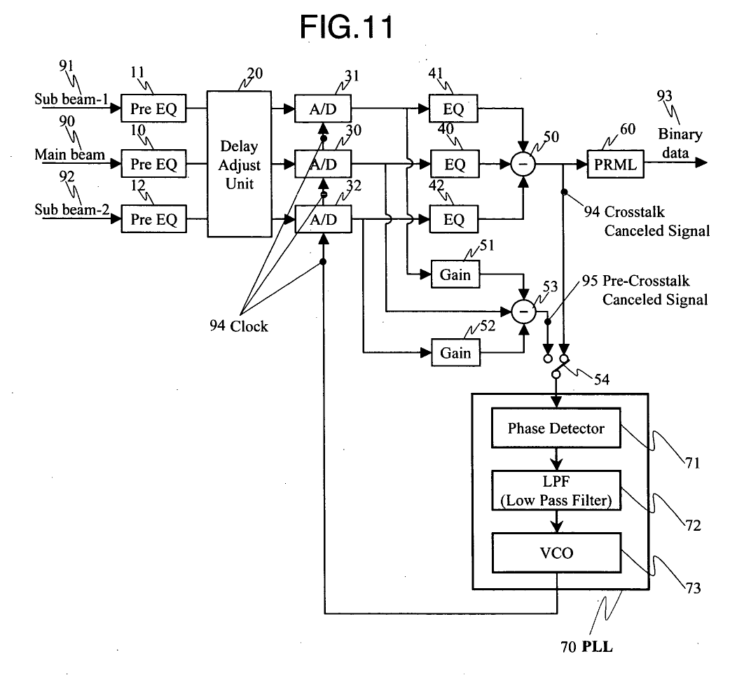

FIG. 11 shows another embodiment of a reproducing circuit in an optical disk apparatus of the present invention. This embodiment is featured in that a switch 54 is provided so that the crosstalk canceled signal 95 and the crosstalk canceled signal 96 can be selectively used. When normal reproduction is performed, the operation of the switch 54 is so controlled that, the crosstalk canceled signal 95 having better signal quality is used. On the other hand, when a fast response is necessary for the PLL circuit in such a case as at the time of an access operation or processing for recovery from a defect in a medium, the operation of the switch 54 is so controlled that the pre-crosstalk canceled signal 96 that reduces the loop delay is used. With such an arrangement, generation of a clock signal that has achieved stability and a fast response can be implemented. Control over the switch 54 is executed by a command from a CPU not shown, or a command from a logic unit that includes a PLL control sequence, not shown.

A description will be given about PRML class selection in the embodiment described above. An appropriate PRML class should be selected according to a linear recording density. Assume that an example of the PRML class selection is given on the basis of a Blu-ray disk using a blue laser light source. When the linear recording density is equivalent to 23-27 GB, for example, a PR class PR (1, 2, 1), a PR class PR (1, 2, 2, 1), a PR class PR (1, 1, 1, 1), a PR class PR(2, 3, 3, 2), or the like should be used. A result of study shows that, under a condition where a shortest mark is shorter than an optical cut-off frequency (λ/NA/4) of an optical head, a PR class PR (1, 2, 2, 2, 1), a PR class PR (1, 2, 3, 3, 2, 1), or the like each having a longer limited run length is suitable. Further, in order to compensate for asymmetry of a reproduced signal and a nonlinear shift due to thermal interference at the time of recording and to improve reproduction performance, a decoding method referred to as a PRML method of a compensation type or an adaptive type should be used. The decoding method is described in “Proc. ISOM2003. Tec. Dig. p34-35”. In this method, a target level changes according to the reproduced signal.

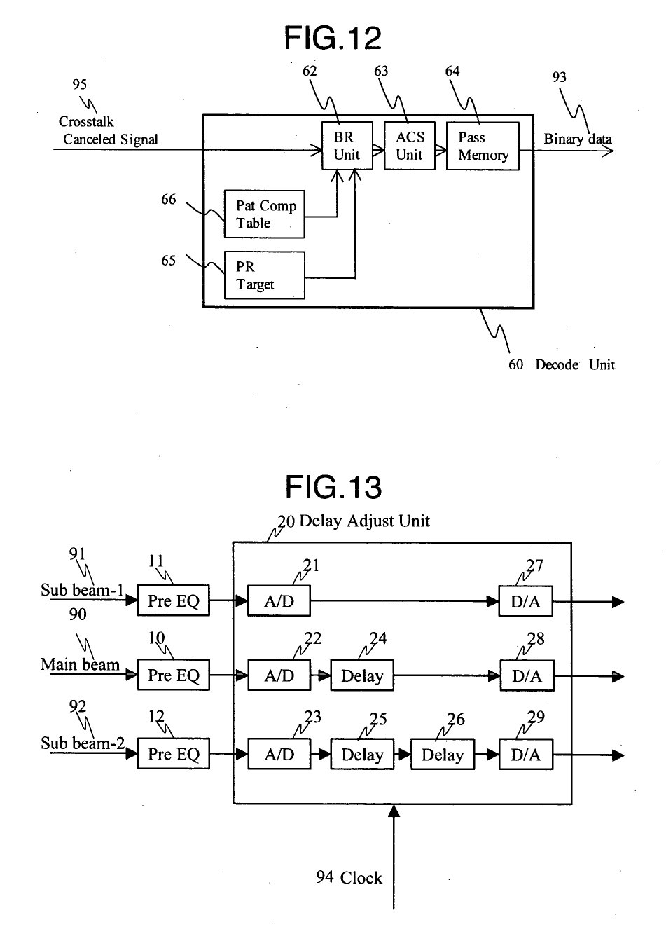

FIG. 12 shows a configuration of a binarization circuit in accordance with the PRML method of the compensation type. A decode unit 60 is comprised of a branch metric calculation unit 62, an add select compare (ACS) unit 63, a pass memory 64, a PR target table 65, and a pattern compensation table 66. The crosstalk canceled signal 95 is supplied to the branch metric calculation unit 62, where the square value (branch metric value) of an error between each bit string of the crosstalk canceled signal 95 and a target value is calculated. As the target value, an initial target value and a compensation value are added to each other, and are used. The initial target value corresponding to each bit string is referred to by the PR target table 65, and the compensation value corresponding to each bit string is referred to by the pattern compensation table 66. The ACS unit 63 adds a branch metric value corresponding to each bit string to a metric value in each state and the state immediately preceding each state. The branch metric value is added sequentially upon a state transition, then processed so as not to be diffused. At this time, a state having a smaller metric value is selected from those in the transition step up to the current time state (usually two states, but only one state sometimes due to the run length limitation). A “state” means a bit string being preserved with respect to one time transition. For example, when the number of PR class bits is 4, the bit string is expressed by 4 bits and the state is expressed by 3 bits. The pass memory 64 stores therein a binary value compounded for each bit string for a long time, and the data is shifted each time the time is updated. Thus, the memory always comes to store the latest data. Each time a transition process is selected, the ACS unit 13 alters the arrangement order of the information stored in the pass memory according to the selected transition process. By repeating the above processing in the above units as described above, information in the pass memory is integrated step by step. After a long time, the same value comes to be stored for each bit string, or so-called path merging is completed. Binary data 93 means binary information taken out from the pass memory when the time is updated. While a PR class target value is obtained with reference to the PR target table 65, such a target value has often been calculated directly with use of a product sum computing unit. The PRML method of the compensation type calculates a new target value by adding the compensation value to the initial target value, then converting the result to a most likelihood binary value.

FIG. 13 shows an embodiment illustrating a detailed configuration of the delay adjust unit. Referring to FIG. 13, the delay adjust unit 20 is constituted of A/D converters 21, 22, and 23, delay units 24, 25, and 26, and D/A converters 27, 28, and 29. Gain adjustment and equalization processing are performed on the reproduced signal 90 from the main beam spot by the analog equalizer 10. Gain adjustment and equalization processing are performed on the reproduced signals 91 and 92 from the sub beam spots by the analog equalizers 11 and 12, respectively. Then, the resulting signals are input to the delay adjust unit 20. These signals are converted to digital signals by the A/D converters 21, 22, and 23, respectively, and delay adjustment is performed on the digital signals by the delay units 24, 25, and 26. Then, the delay-adjusted signals are retorted to analog signals again by the D/A converters 27, 28, and 29. The delay units 24, 25, and 26 are digital delay units each constituted of a shift register. One delay amount is the amount of a time corresponding to a spot interval in a track direction. In the configuration in FIG. 13, the reproduced signal 92 indicates a response from the sub beam spot that precedes the main beam spot in time, and the reproduced signal 91 indicates a response from the sub beam spot that is delayed from the main beam spot in time. An operation of the delay adjust unit 20 is controlled in synchronization with a clock 94 generated by the PLL circuit shown in FIG. 1. With this arrangement, even in such a case as at the time of an access, where the rotation speed of the disk is different, the PLL circuit generates the clock that tracks the reproduced signals. Accordingly, adjustment of the delay amount dependent on the spot interval can be correctly made at all times.

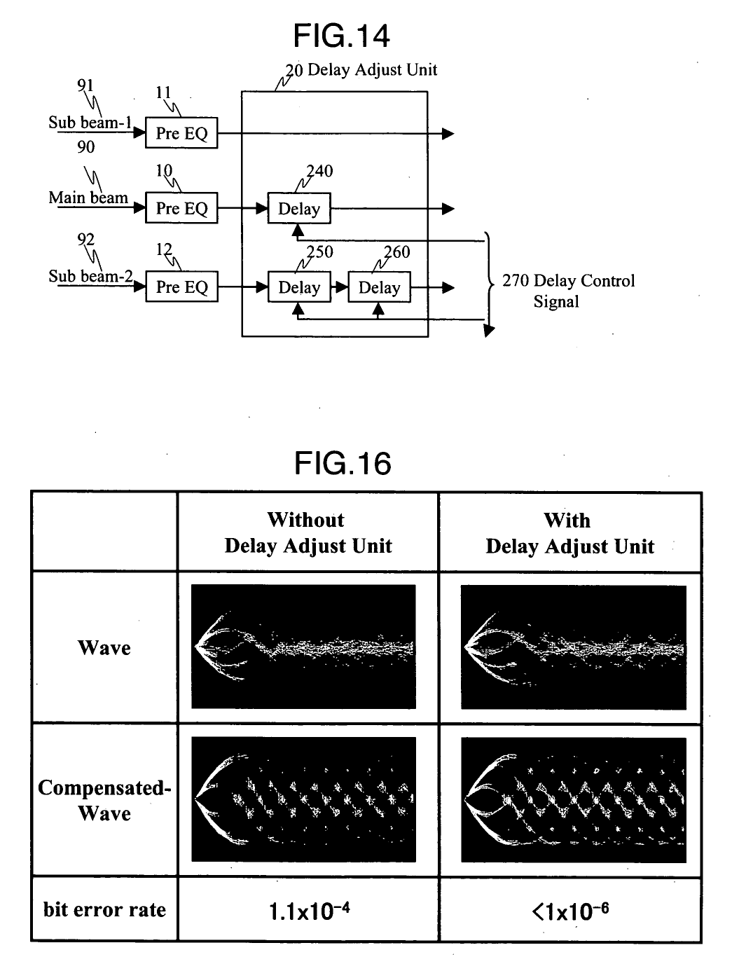

FIG. 14 shows an embodiment illustrating a configuration of the delay adjust unit that uses analog delay lines to simplify the configuration. In this case as well, delay adjustment is performed by delay units 240, 250, and 260. In this case, the analog delay lines have disadvantages that the amount of delay is semi-fixed, and that distortion of the reproduced signal greatly increases when a delay exceeding 100 ns is given. Further, since an effective delay correction range by an FIR filter in a subsequent stage is approximately ±1 Tw, it is necessary to give consideration so that the accuracy of the delay amount does not exceed this effective delay correction range. As shown in FIG. 14, it is preferable to use elements that can adjust the delay amount according to a command from a delay control signal 270 or the like. Such adjustable control of the delay amount can be sometimes performed by the amount of current using a gate delay, for example. At any rate, when the analog delay lines are employed, consideration must be given so that the delay amount is 50 ns or less by increasing a reproduction speed or narrowing an interval between spots.

### Second Embodiment

FIG. 16 shows experimental results showing an effect of improvement in the signal quality by the delay adjust unit of the present invention. These results are obtained under a recording condition in which a 120-mm diameter optical disk having 50 GB capacity per side was used. The recording condition is the same as that described in Nonpatent Document 1. By adding the delay adjust unit as shown in FIG. 10, the PLL circuit was stabilized, and a bit error rate was improved from 1.1×10⁻⁴ to 1×10⁻⁶ or less. Each of compensated waveforms in FIG. 16 was obtained by subtracting from a reproduced signal the amount of compensation obtained according to the PRML method of the compensation type, and the effect of improvement in the signal quality could be intuitively evaluated. Herein, the signal quality of the reproduced signal obtained when the delay adjust unit was added was compared with the signal quality of the reproduced signal obtained when the delay adjust unit was not added. In this experiment, even when the delay adjust unit was not added, the PLL was locked, and in that fine condition, the signal quality of the reproduced signal was checked. When an experiment is carried out a signal reproduced with the delay adjust unit and a signal reproduced without the delay adjust unit and the signal quality of the signal reproduced without the delay adjust unit becomes worse than in the case shown in FIG. 16, a difference in the bit error rates of the reproduced signals becomes more noticeable.

### Third Embodiment

Optical Disk Apparatus

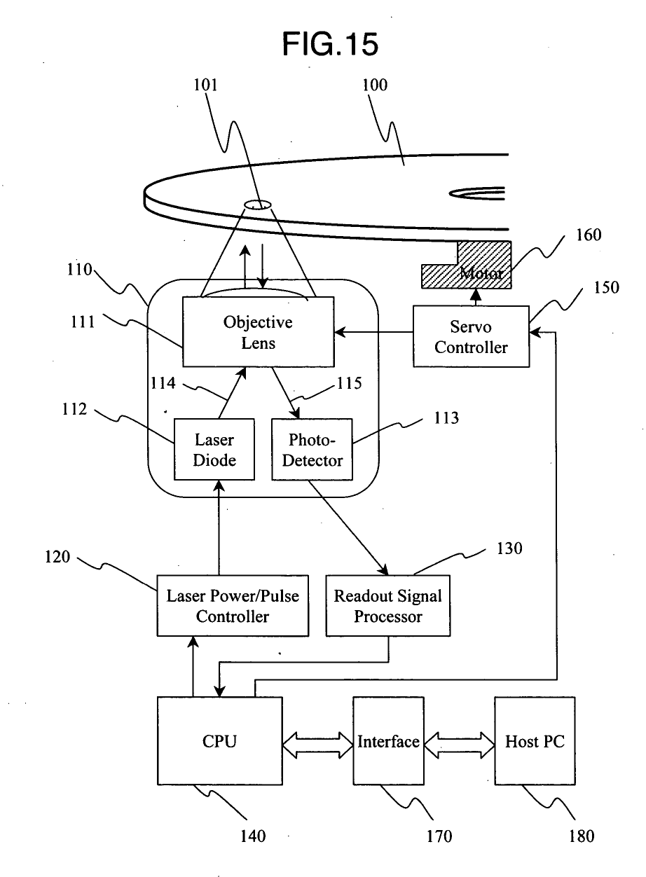

FIG. 15 shows an embodiment illustrating an optical disk apparatus according to the present invention. An optical disk medium 100 is rotated by a motor 160. A laser power/pulse controller 120 controls current to be passed through a semiconductor laser diode 112 within an optical head 110, thereby generating a laser beam 114. The laser beam 114 is focused through an objective lens 111 and forms a beam spot 101 on the optical disk medium 100. A reflected light 115 from the beam spot 101 is detected by a photodetector 113 through the objective lens 111. The photodetector is comprised of a photodetecting element divided into a plurality of portions. A readout signal processing circuit 130 uses a signal detected by the optical head 110 to reproduce information recorded on the optical disk medium 100. When recording is performed, the laser power/pulse controller 120 converts predetermined recording data to a predetermined recording pulse current, and performs control so that a pulse light is emitted from the semiconductor laser diode 112. The reproducing circuit of the present invention shown in FIG. 1 is included in the readout signal processing circuit 130. With this arrangement, stable generation of the clock in the circuit of a crosstalk cancellation system becomes possible. A highly reliable optical memory with a large capacity can be thereby implemented.

The present invention is used for a large-capacity optical disk apparatus.

It should be further understood by those skilled in the art that although the foregoing description has been made on embodiments of the invention, the invention is not limited thereto and various changes and modifications may be made without departing from the spirit of the invention and the scope of the appended claims.

1. An optical disk apparatus comprising:
means for imaging at least first, second, and third beam spots on an information recording surface of an optical disk medium;
a first photodetector which detects reflected light from the first beam spot;
a second photodetector which detects reflected light from the second beam spot;
a third photodetector which detects reflected light from the third beam spot;
a first analog equalizer which adjusts at least one of a gain of a first output signal from the first photodetector and a frequency characteristic of the first output signal;
a second analog equalizer which adjusts at least one of a gain of a second output signal from the second photodetector and a frequency characteristic of the second output signal;
a third analog equalizer which adjusts at least one of a gain of a third output signal from the third photodetector and a frequency characteristic of the third output signal;
a first analog-to-digital (A/D) converter which converts an output of the first analog equalizer to a first digital signal;
a second A/D converter which converts an output of the second analog equalizer to a second digital signal;
a third A/D converter which converts an output of the third analog equalizer to a third digital signal;
a first digital equalizer which adjusts at least one of a gain of the first digital signal and a frequency characteristic of the first digital signal to generate a first digital equalized signal;
a second digital equalizer which adjusts at least one of a gain of the second digital signal and a frequency characteristic of the second digital signal to generate a second digital equalized signal;
a third digital equalizer which adjusts at least one of a gain of the third digital signal and a frequency characteristic of the third digital signal to generate a third digital equalized signal;
a crosstalk cancel operation circuit which subtracts the second digital equalized signal and the third digital equalized signal from the first digital equalized signal to generate a crosstalk reduced signal;
a binarization circuit which binarizes an output signal of the crosstalk cancel operation circuit;
a clock generating circuit which generates a clock signal for determining sampling timings of the first to third A/D converters; and
a delay adjusting circuit coupled between the first analog equalizer and the first A/D converter, the second analog equalizer and the second A/D converter, and the third analog equalizer and the third A/D converter.

2. The optical disk apparatus according to claim 1, wherein the delay adjusting circuit comprises A/D converters, shift registers, and D/A converters.

3. The optical disk apparatus according to claim 1, wherein as an input signal to the clock generating circuit, a precrosstalk reduced signal is employed, the precrosstalk reduced signal being obtained by subtracting from the first digital signal a value obtained by multiplying the second digital signal by a first gain and a value obtained by multiplying the third digital signal by a second gain, the first gain being the gain of the second digital signal and the second gain being the gain of the third digital signal.

4. The optical disk apparatus according to claim 3, further comprising a switch which performs switching between the precrosstalk reduced signal and the crosstalk reduced signal, for supply to the clock generating circuit.

5. The optical disk apparatus according to claim 1, wherein the binarization circuit is based on an adaptive PRML (partial response maximum likelihood) method in which a target level changes according to a reproduction signal from the information recording surface of the optical disk medium.

6. The optical disk apparatus according to claim 1, wherein the delay adjusting circuit is of an analog type in which delay adjustment is performed on an analog signal by a shift register.

7. A readout signal processing circuit for reproducing information recorded on an optical disk medium by detecting first, second, and third reflected lights from three beam spots irradiated onto the optical disk medium, respectively, the readout signal processing circuit comprising:
a first analog equalizer which adjusts at least one of a gain of a first output signal generated from the first reflected light and a frequency characteristic of the first output signal;
a second analog equalizer which adjusts at least one of a gain of a second output signal generated from the second reflected light and a frequency characteristic of the second output signal;
a third analog equalizer which adjusts at least one of a gain of a third output signal generated from the third reflected light and a frequency characteristic of the third output signal;
a first A/D converter which converts an output of the first analog equalizer to a first digital signal;
a second A/D converter which converts an output of the second analog equalizer to a second digital signal;
a third A/D converter which converts an output of the third analog equalizer to a third digital signal;
a first digital equalizer which adjusts at least one of a gain of the first digital signal and a frequency characteristic of the first digital signal to generate a first digital equalized signal;
a second digital equalizer which adjusts at least one of a gain of the second digital signal and a frequency characteristic of the second digital signal to generate a second digital equalized signal;
a third digital equalizer which adjusts at least one of a gain of the third digital signal and a frequency characteristic of the third digital signal to generate a third digital equalized signal;
a crosstalk cancel operation circuit which subtracts the second digital equalized signal and the third digital equalized signal from the first digital equalized signal to generate a crosstalk reduced signal;
a binarization circuit which binarizes an output signal of the crosstalk cancel operation circuit;
a clock generating circuit which generates a clock signal for determining sampling timings of the first to third A/D converters; and
a delay adjust circuit provided between the first analog equalizer and the first A/D converter, the second analog equalizer and the second A/D converter, and the third analog equalizer and the third A/D converter.
